(19) United States
(12) Patent Application Publication
(10) Pub. No.: US 2012/0327010 A1
(43) Pub. Date: Dec. 27, 2012

(54) POINTING DEVICE

(75) Inventors: Tsung-Ting LEE, Chiayi County (TW); Hsiung-Kuang TSAI, Taipei City (TW)

(73) Assignee: SOFT HAPTIC TECHNOLOGY INC., New Taipei City (TW)

(21) Appl. No.: 13/607,103

(22) Filed: Sep. 7, 2012

Related U.S. Application Data
(63) Continuation-in-part of application No. 12/786,836, filed on May 25, 2010.

(30) Foreign Application Priority Data
Dec. 21, 2009 (TW) 098143955

(51) Int. Cl. G06F 3/041

(52) U.S. Cl. 345/173

(57) ABSTRACT

A pointing device includes a covering structure and a touch sensing unit. The covering structure is made by a flexible material. The touch sensing unit is buried in the covering structure and has at least one touch-emitting electrode and at least one touch-receiving electrode. At least one touch signal is emitted by the touch-emitting electrode, and then a touch information is transmitted to the touch-receiving electrode through an user or an object. The pointing device of this invention is combined with the touch sensing technology to move the curser without the need of sliding over a certain area on a surface, thereby improving the using convenience.

### CROSS REFERENCE TO RELATED APPLICATIONS

This application is a Continuation-In-Part (CIP) of U.S. Ser. No. 12/786,836, filed May. 25, 2010, which claims priority under 35 U.S.C. §119(a) on Patent Application No(s). 098143955 filed in Taiwan, Republic of China on Dec. 21, 2009, the entire contents of which are hereby incorporated by reference.

### BACKGROUND OF THE INVENTION

1. Field of Invention

The invention relates to a pointing device.

2. Related Art

In the information era, computers have become indispensible articles for daily use. In practice, the keyboard and mouse are commonly used to serve as the human-machine interfaces for communicating the user and computer.

The present mouse includes a sensor disposed at the bottom side of the mouse, so that when the user slides the mouse on a plane, the cursor displayed on the screen can be moved correspondingly. Accordingly, the user can control the movement of the cursor by moving the mouse, for example, to point an icon, and click the button of the mouse to execute one of various programs of the computer corresponding to the icon.

However, the user needs to hold the mouse and slide it on a plane to make the sensor at the bottom side of the mouse sense the sliding direction and distance so that the cursor on the screen can move correspondingly. So, when the user operates the mouse, a plane of a certain area is necessary for allowing the mouse to slide thereon, which may cause restriction on usage.

On the other hand, the touch control feature is easier for operation and more intuitive for users. Besides, with the progress of touch technology, more and more electronic apparatuses are equipped with touch control interface as the human-machine interface.

### SUMMARY OF THE INVENTION

In view of the foregoing, an objective of the invention is to provide a pointing device that combined with touch sensing feature to move a cursor without the need of sliding over a certain area on a surface, thereby improving the convenience of usage.

To achieve the above objective, a pointing device of the invention includes a covering structure and a touch sensing unit. The covering structure is made by a flexible material. The touch sensing unit is buried in the covering structure and has at least one touch-emitting electrode and at least one touch-receiving electrode. At least one touch signal is emitted by the touch-emitting electrode, and then a touch information is transmitted to the touch-receiving electrode through an user or an object.

In one embodiment, the covering structure is hermetically sealed.

In one embodiment, the touch-emitting electrode and the touch-receiving electrode are disposed at the same side or different sides.

In one embodiment, the covering structure has at least one bent portion.

In one embodiment, the distance from an exterior surface of the covering structure to the touch-emitting electrode or to the touch-receiving electrode is smaller than 5 mm.

In one embodiment, the touch sensing unit senses a clicking and a movement caused by the user or the object on the touch-emitting electrode.

In one embodiment, the object has an emitter for transmitting the touch information to the touch-receiving electrodes.

In one embodiment, the touch sensing unit further has a flexible circuit board, and the touch-emitting electrodes and the touch-receiving electrodes are disposed on the flexible circuit board.

In one embodiment, the pointing device further comprises a feedback unit. When the covering structure is touched or pressed to enable the touch sensing unit to generate the touch information signal, the feedback unit generates a feedback signal.

In one embodiment, the feedback signal is an optic signal, a vibrational, or an acoustic signal.

In one embodiment, the covering structure's surface has at least two regions and the material, roughness, temperature, softness, or their combination of the regions is different from each other.

In one embodiment, the touch-emitting electrodes are disposed in array.

In one embodiment, the touch-emitting electrodes are a plurality of column electrodes or a plurality of row electrodes of a display panel.

As mentioned above, in the pointing device of the invention, the covering structure covers the touch sensing unit and is made by a flexible material, and besides, the touch sensing unit is buried in the covering structure and has at least one touch-emitting electrode and at least one touch-receiving electrode. Thus, the user can hold the pointing device, and make the hand motions, such as touching, tapping, or sliding, to input commands, such as moving curser, clicking button, dragging the page, rotating the page, etc. Therefore, the user can operate the device by holding in hand. In other words, by sensing the touch activity, the pointing device can control the cursor to move without the need of sliding over a certain area on a surface, thereby improving the convenience of usage.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic view of a pointing device according to a preferred embodiment of the invention, and FIG. 1B is a schematic view showing an enlargement of a portion of the pointing device;

FIGS. 2A and 2B are schematic views of the touch sensing circuit of the pointing device of the preferred embodiment of the invention;

FIG. 3 is a schematic diagram showing the situation of using the pointing device of the preferred embodiment of the invention; and

FIGS. 4 and 5 are schematic diagrams of the pointing devices of various aspects according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

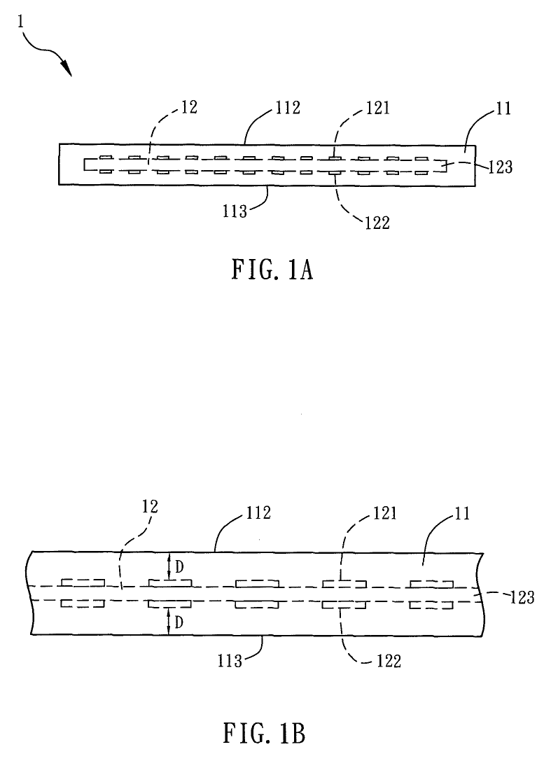

FIG. 1A is a schematic view of a pointing device 1 according to a preferred embodiment of the invention, and FIG. 1B is a schematic view showing an enlargement of a portion of the pointing device 1. In the embodiment, the pointing device 1 means the device as a human-machine interface, for example, replacing the mouse. The pointing device 1 includes a covering structure 11 and a touch sensing unit 12.

The covering structure 11 is made by flexible material. In this embodiment, the covering structure 11 is shaped like a plate as an example. It can be any other shapes and forms without limitation.

The touch sensing unit 12 is buried in the covering structure 11, and has at least one touch-emitting electrode 121 and at least one touch-receiving electrode 122. Herein, there are a plurality of touch-emitting electrode 121 and a plurality of touch-receiving electrode 122, for example, and besides, the touch-emitting electrodes 121 are disposed in array. Practically, a display panel can be disposed into the covering structure 11, and the column electrodes or row electrodes of the display panel can be used as the touch-emitting electrodes 121. The display panel is, for example, a self-luminous display panel or a non-self-luminous display panel (such as a liquid crystal display panel). The display panel can be disposed in an inverse way to enhance the identification efficiency of the touch control.

The touch sensing unit 12 can be made by using a flexible material. In this embodiment, the covering structure 11 is sealed. The covering structure 11 can contact with the touch sensing unit 12 by injection molding or insert molding so that the covering structure 11 can tightly cover the touch sensing unit 12. That is, the covering structure 11 can directly contact the touch-emitting electrode 121 or the touch-receiving electrode 122. The distance D from an exterior surface 112 of the covering structure 11 to the touch-emitting electrode 121 or to the touch-receiving electrode 122 can be smaller than 5 mm. Because the covering structure 11 is very thin, the operations of the touch-emitting electrode 121 and the touch-receiving electrode 122 will not be hindered. The covering structure 11 and the touch sensing unit 12 can be separately manufactured and then assembled together. The hermetically sealed feature of the covering structure 11 is not a necessary requirement of this invention. In another aspect, the covering structure 11 can be unsealed.

The surface of covering structure 11 has two different regions 112 and 113. The material, roughness, temperature, softness, or their combination of the regions 112 and 113 can be different from each other so that the user can identify the area of the touch-emitting electrode 121 for example.

During the operation, a user is coupled with at least one touch signal emitted by the touch-emitting electrode 121, and then a touch information is transmitted to the touch-receiving electrode 122 through the user or an object. The coupling can occur when the user contacts or approaches the surface over the touch-emitting electrode 121. In other words, the touch sensing unit senses the motion of clicking and/or moving of the user or the object on the touch-emitting electrode 121. The motion can be a contact type or a non-contact type. If the user or the object is just as a transmitter, the touch information can be almost the same as the touch signal. Otherwise, the object can receive and then process the touch signal to produce the touch information. The information can be transmitted to the touch-receiving electrode 122 by the user or the object in a coupling way (including a contact type or a non-contact type). Otherwise, the object has an emitter for transmitting the touch information to the touch-receiving electrode 122. For example, the user wears a ring capable of the Bluetooth transmission (as the object), which receives the touch signal coupled by the user's body from the touch-emitting electrode and then transmit the touch information to the touch-receiving electrode through the Bluetooth transmission. Further, the pointing device 1 can include a processer to process the touch information.

After received by the touch-receiving electrode 122, the touch information can be transmitted outside in a wired or wireless way, for example, to a cell phone, a notebook computer, or a tablet computer for the touch control.

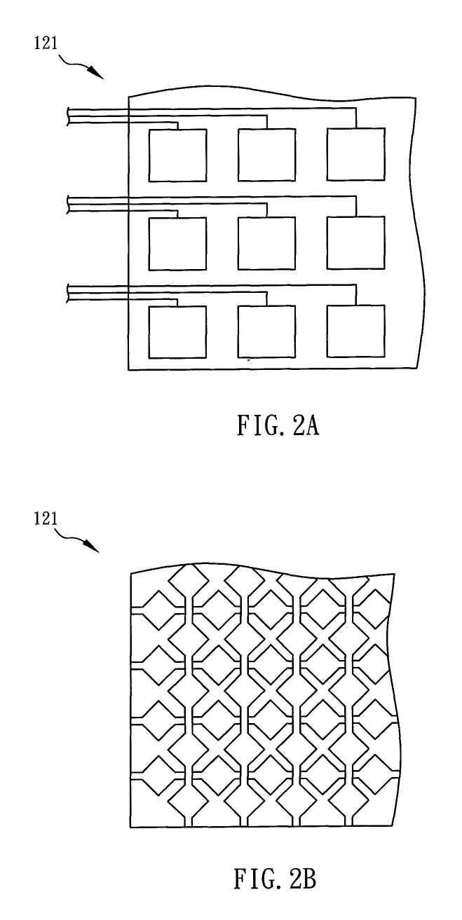

The touch-emitting electrode 121 and the touch-receiving electrode 122 can be disposed at the same side or different sides of the surface, for example, they are disposed at the different sides. In the embodiment, the touch sensing unit 12 can further include a flexible circuit board 123, and the touch-emitting electrodes 121 and the touch-receiving electrodes 122 are disposed at two opposite sides of the flexible circuit board 123 respectively. To be noted, the touch sensing unit 12 can have a plurality of flexible circuit boards 123, and the touch-emitting electrodes 121 and the touch-receiving electrodes 122 are disposed on the different flexible circuit boards 123 respectively. Each of the touch-emitting electrodes 121 and the touch-receiving electrodes 122 can have at least a touch sensing circuit, which can be, for example, a single-layer circuit (see FIG. 2A) or a double-layer circuit. Besides, the touch sensing circuit can also be a matrix double-layer circuit (see FIG. 2B).

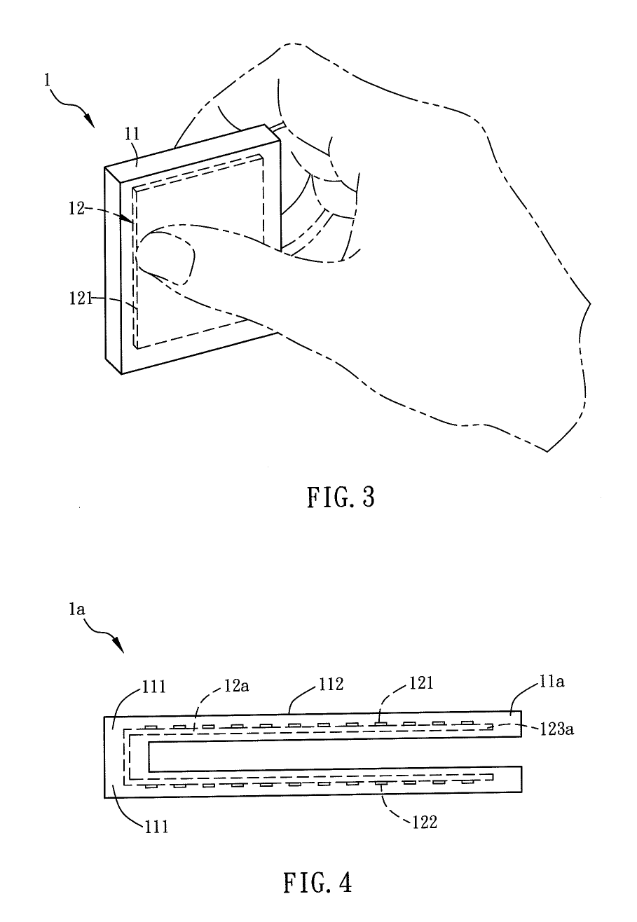

As shown in FIGS. 1A and 3, when the user holds the pointing device 1 (for example, the thumb of the user is located on the side of the touch-emitting electrodes 121, and the other fingers are located on the side of the touch-receiving electrodes 122), the user can control the thumb to touch or slide over the surface of touch-emitting electrodes 121. The touch signal, emitted from the touch-emitting electrodes, can be coupled through the thumb and other fingers to the touch-receiving electrodes. The actions of the thumb, for example, tapping or sliding, over the touch-emitting electrodes can be identified according to the received touch information. Therefore, the user can hold the pointing device 1 to operate it. In other words, by holding the pointing device 1, the user can move the cursor without the need of sliding over a certain area on a surface, thereby improving the convenience of usage.

Besides, the pointing device 1 can include a feedback unit (not shown). When the covering structure 11 is touched or pressed to enable the touch sensing unit 12 to generate the touch information, the feedback unit generates a feedback signal. The feedback signal can be an optic signal (e.g. the variation of the brightness or color displayed by the pointing device 1), a vibrational signal (e.g. the vibration generated by the pressed portion or by the whole pointing device 1), or an acoustic signal (e.g. the sounds made by the pointing device 1 or a sound device of the computer for indicating the operation of the clicking or sliding by the user) to arouse the user's perception.

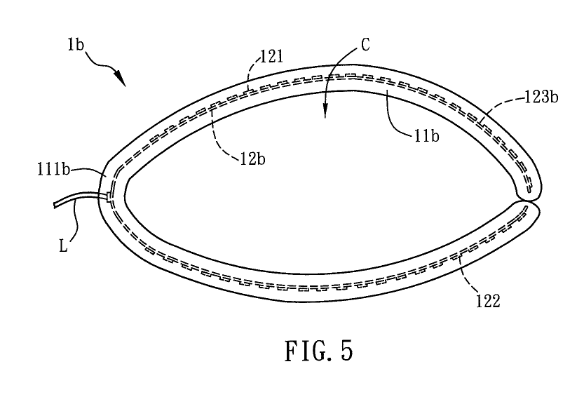

FIG. 4 is a schematic diagram of another pointing device 1a of the embodiment. As shown in FIG. 4, the covering structure 11a of the pointing device 1a can have at least a bent portion 111. In the embodiment, the covering structure 11a is illustrated to have two bent portions 111, and thus the cross-section of the pointing device 1a in FIG. 4 is similar to a “U” shape. Of course, the cross-section of the pointing device 1a can have other shapes.

Because of the flexibility of flexible circuit board 123a, the touch-emitting electrodes 121 and the touch-receiving electrodes 122 can be disposed at the opposite sides of the pointing device 1a, and that is, the touch-emitting electrodes 121 and the touch-receiving electrodes 122 are respectively disposed at different levels. Otherwise, the touch-emitting electrodes 121 and the touch-receiving electrodes 122 can be disposed on the separate flexible circuit boards or inflexible printed circuit boards (PCB).

FIG. 5 is a schematic diagram of another pointing device 1b of the embodiment. As shown in FIG. 5, the covering structure 11b of the pointing device 1b has a single bent portion 111b so that the cross-section of the pointing device 1b is similar to a “C” shape. The touch sensing unit 12b is buried in the covering structure 11b, and the covering structure 11b is formed into a chamber C. The pointing device 1b can transmit the touch information through a wire L. To be noted, the pointing devices 1a and 1b just provide various examples of the structure, but not for limiting the scope of the invention.

In summary, in the pointing device of the invention, the covering structure covers the touch sensing unit and is made by using a flexible material, and besides, the touch sensing unit is buried in the covering structure and has at least one touch-emitting electrode and at least one touch-receiving electrode. Thus, the user can hold the pointing device, and then use it by the touch control, such as touching or sliding, to execute the functions of, for example, moving the cursor, clicking the button, dragging the page, turning the page, etc. Therefore, the user just holds the pointing device to operate it. In other words, the pointing device can control the cursor to move without the need of sliding over a certain area on a surface, but by the touch control, thereby improving the convenience of usage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A pointing device, comprising:
a covering structure made by a flexible material; and
a touch sensing unit buried in the covering structure and having at least one touch-emitting electrode and at least one touch-receiving electrode, wherein a user is coupled with at least one touch signal emitted by the touch-emitting electrode, and then a touch information is transmitted to the touch-receiving electrode through the user or an object.

2. The pointing device as recited in claim 1, wherein the covering structure is hermetically sealed.

3. The pointing device as recited in claim 1, wherein the touch-emitting electrode and the touch-receiving electrode are disposed at the same side or different sides.

4. The pointing device as recited in claim 1, wherein the covering structure has at least one bent portion.

5. The pointing device as recited in claim 1, wherein the distance from an exterior surface of the covering structure to the touch-emitting electrode or to the touch-receiving electrode is smaller than 5 mm.

6. The pointing device as recited in claim 1, wherein the touch sensing unit senses a clicking or a movement caused by the user or the object on the touch-emitting electrode.

7. The pointing device as recited in claim 1, wherein the object has an emitter for transmitting the touch information to the touch-receiving electrodes.

8. The pointing device as recited in claim 1, wherein the touch sensing unit further has a flexible circuit board, and the touch-emitting electrodes and the touch-receiving electrodes are disposed on the flexible circuit board.

9. The pointing device as recited in claim 1, further comprising:
a feedback unit, wherein when the covering structure is touched or pressed to enable the touch sensing unit to generate the touch information signal, the feedback unit generates a feedback signal.

10. The pointing device as recited in claim 9, wherein the feedback signal is an optic signal, a vibrational, or an acoustic signal.

11. The pointing device as recited in claim 1, wherein the covering structure's surface has at least two different regions, and the material, roughness, temperature, softness, or their combination of the regions is different from each other.

12. The pointing device as recited in claim 1, wherein the touch-emitting electrodes are disposed in array.

13. The pointing device as recited in claim 1, wherein the touch-emitting electrodes are a plurality of column electrodes or a plurality of row electrodes of a display panel.
